(19) United States
(12) Patent Application Publication
(10) Pub. No.: US 2005/0177599 A1
(43) Pub. Date: Aug. 11, 2005

(54) System and method for complying with anti-spam rules, laws, and regulations

(75) Inventor: Joshua Goodman, Redmond, WA (US)

Correspondence Address: SENNIGER, POWERS, LEAVIT & ROEDEL, ONE METROPOLITAN SQUARE, 16TH FLOOR, ST. LOUIS, MO, 63102, US

(73) Assignee: Microsoft Corporation

(21) Appl. No.: 10/774,995

(22) Filed: Feb. 9, 2004

(51) Int. Cl. G06F 17/00

(52) U.S. Cl. 707/104.1

(57) ABSTRACT

System and method for a sender of communications to comply with a predetermined time limit. Computer-executable instructions are adapted to receive an incoming communication from a recipient of communications. Computer-executable instructions are adapted to store data indicating a last time that the incoming communication is received by the sender. Computer-executable instructions are adapted to send a communication to the recipient if the stored data indicates that the time between the last time that the incoming communication is received by the sender and a present time does not exceed the predetermined time limit.

### TECHNICAL FIELD

Embodiments of the present invention relate to the field of sending a communication that complies with anti-spam laws, rules, and regulations. In particular, embodiments of the present invention relate to tracking interactions between a recipient and a sender to determine if a preexisting business relationship exists between the recipient and the sender.

### BACKGROUND OF THE INVENTION

Every day, millions of people receive dozens of unsolicited commercial mails (e.g., electronic mail or email), known popularly as “spam.” Some users see spam as a minor annoyance, while others are so overwhelmed with spam that they are forced to switch email addresses. Once considered a mere nuisance, spam has grown to account for a large percentage of the mail volume on the Internet. A recent statistic suggests that spam contributes to more than one-third of total email traffic and that on average an Internet user receives more than six pieces of spam each day. Furthermore, if the growth trend continues, spam volume is about to overtake that of legitimate emails. Spam generates other significant problems as well. Specifically, people fear that spam may expose pornography or inappropriate contents to minors, clog mail boxes, and cost businesses billions of dollars in lost productivity and other expenses.

As discussed, once considered a mere nuisance, spam has grown to account for a large percentage of the mail volume on the Internet. The unwanted traffic generated by spam stands to affect local networks, the infrastructure, and the way that people use email. In addition, spammers are beginning to set up their own websites that cater to or encourage spamming, which makes the spam problem even worse. The scale, growth, and effect of spam on the Internet have generated a considerable interest in addressing the problem.

As spam becomes an increasing larger problem and increasing unpopular, an increasing number of laws and rules have been adopted or proposed to regulate spam. For example, California's anti-spam law, which becomes effective in January 2004, establishes two levels of protections. First, the law requires opt-in, that is, true consent, for unsolicited commercial email advertisements to persons with whom the sender does not have a prior or current business relationship. Second, it offers consumers opt-out protection to stop spam from businesses with which the consumers have a preexisting or current relationship. This allows a consumer to get off an email list of someone with whom the consumer has done business. Violators of the law will be subject to penalties of $1,000 per email, up to $1 million per incident. In addition, California's anti-spam law can be enforced by the Attorney General or through a private lawsuit filed by consumers.

Similar to California's anti-spam law, many other states' or countries' anti-spam laws restrict a business from sending communications to people with whom the business does not have a preexisting business relationship. Violating these anti-spam laws may subject a business to considerable penalties. In addition, a number of independent self-regulatory organizations (SROs) are maintaining a list of email senders who agree not to spam (e.g., those senders who agree not to send a commercial email to people with whom they do not have a preexisting business relationship). A proliferation of anti-spam laws in different states or countries can lead to the need to keep track of a complex set of facts in order to comply with the different anti-spam laws. Furthermore, many anti-spam laws do not distinguish mass mailings from individual mailings, thus making compliance with the laws even more difficult.

Some known systems attempt to effect compliance with the anti-spam laws by automatically processing requests to opt-out from preexisting relationships. In particular, such known systems may provide a simple method (e.g., replying to an email message or clicking on a clink) for consumers to opt-out from a mailing list maintained by a business. However, these known systems do not keep track of all of the information needed to comply with the many anti-spam laws, rules, and regulations.

Accordingly, a solution that effectively assists a sender to comply with different anti-spam rules, laws, and regulations is desired to address one or more of these and other disadvantages.

### SUMMARY OF THE INVENTION

Embodiments of the invention overcome one or more deficiencies in the known art by providing, among other things, a method and system for a sender of communications to comply with anti-spam rules, laws, and regulations. One embodiment of the invention effectively permits tracking a whether preexisting business relationship exists between the sender and a potential recipient to determine if sending a communication to the potential recipient complies with the anti-spam rules, laws, and regulations. This embodiment of the invention advantageously allows maintaining a list of recipients with whom a time limit on preexisting business relationship approaches and then inducing a recipient on the list of recipients to renew the relationship. Embodiments of the invention further advantageously permit identifying a location of a potential recipient. According to one or more embodiments of the invention, the location of a potential recipient may be identified based on the postal address, Internet protocol (IP) address, telephone number, or domain name of the potential recipient. One or more other embodiments of the invention further advantageously allow a sender to comply with different anti-spam rules, laws, and regulations of different countries or states by identifying the location of a potential recipient. At least one embodiment of the invention also advantageously allows identifying if a potential recipient is included in a do-not-spam list to determine whether to send a communication to the potential recipient. Moreover, the features of embodiments of the present invention described herein are less laborious and easier to implement than currently available techniques as well as being economically feasible and commercially practical.

Briefly described, a method employing aspects of the invention allows a sender of communications to comply with a predetermined time limit. The method includes receiving an incoming communication from a recipient of communications. The method also includes storing data indicating a last time that the incoming communication is received by the sender. If the stored data indicates that the time between the last time that the incoming communication is received by the sender and a present time does not exceed the predetermined time limit, the method further includes sending a communication to the recipient.

In another embodiment of the invention, a method employing aspects of the invention allows a sender of communications to comply with a rule, law, or regulation. The method includes receiving an incoming communication from a recipient of communications. The method also includes identifying a location of the recipient based on the received incoming communication. The method further includes storing data indicating the identified location of the recipient. The method includes determining if a communication complies with a rule, law, or regulation of the identified location of the recipient. If the communication is determined to comply with the rule, law, or regulation of the identified location of the recipient, the method also includes sending the communication to the recipient.

In yet another embodiment of the invention, a system employing aspects of the invention is adapted to allow a sender of communications to comply with a predetermined time limit. The system includes a memory area to store data indicating a last time that an incoming communication from a recipient is received by the sender. The system also includes a device to send a communication to the recipient if the stored data indicates that the time between the last time that the incoming communication is received by the sender and a present time does not exceed the predetermined time limit.

In further yet another embodiment of the invention, a system employing aspects of the invention is adapted to allow a sender of communications to comply with a rule, law, or regulation. The system includes computer-executable instructions to identify a location of a recipient based on an incoming communication received from the recipient. The system also includes a memory area to store data indicating the identified location of the recipient. The system further includes computer-executable instructions to determine if a communication complies with a rule, law, or regulation of the identified location of the recipient. The system includes a first device to send the communication to the recipient if the communication is determined to comply with the rule, law, or regulation of the identified location of the recipient.

In further yet another embodiment of the invention, computer-readable media employing aspects of the invention have computer-executable components for a sender of communications to comply with a predetermined time limit. The computer-readable media include a receiving component for receiving an incoming communication from a recipient of communications. The computer-readable media also include a storage component for storing data indicating a last time that the incoming communication is received by the sender. The computer-readable media further include a sending component for sending a communication to the recipient if the stored data indicates that the time between the last time that the incoming communication is received by the sender and a present time does not exceed the predetermined time limit.

One or more computer-readable media having computer-executable instructions for a sender to comply with a rule, law, or regulation embody further aspects of the invention.

Alternatively, one embodiment of the invention may comprise various other methods and apparatuses.

Other features will be in part apparent and in part pointed out hereinafter.

### BRIEF DESCRIPTION OF THE DRAWINGS

FIG. 1 is a block diagram of an exemplary client-based system according to one embodiment of the invention adapted to allow a sender of communications to comply with anti-spam rules, laws, and regulations.

FIG. 2 is a block diagram of an exemplary server-based system according to one embodiment of the invention adapted to allow a sender of communications to comply with anti-spam rules, laws, and regulations.

FIG. 3 is a flow diagram illustrating one method according to one embodiment of the invention for identifying a date and time of an incoming communication received from a potential recipient and a location of the potential recipient.

FIGS. 4A and 4B are flow diagrams illustrating one method according to one embodiment of the invention for determining if a communication to be sent to a recipient complies with anti-spam rules, laws, and regulations.

FIG. 5 is a flow diagram illustrating one method according to one embodiment of the invention for establishing or reestablishing a preexisting business relationship.

FIG. 6 is a flow diagram illustrating one method according to one embodiment of the invention for maintaining a preexisting business relationship.

FIG. 7 is a block diagram illustrating an exemplary embodiment of a suitable computing system environment in which one embodiment of the invention may be implemented.

Corresponding reference characters indicate corresponding parts throughout the drawings.

### DETAILED DESCRIPTION OF THE INVENTION

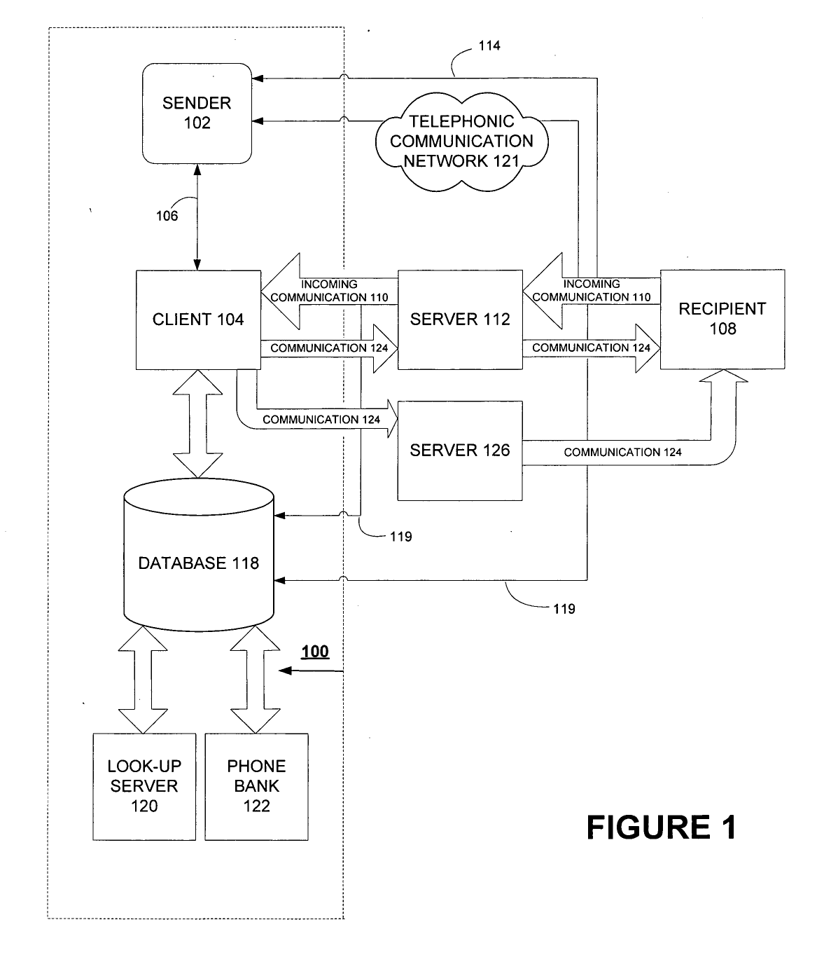

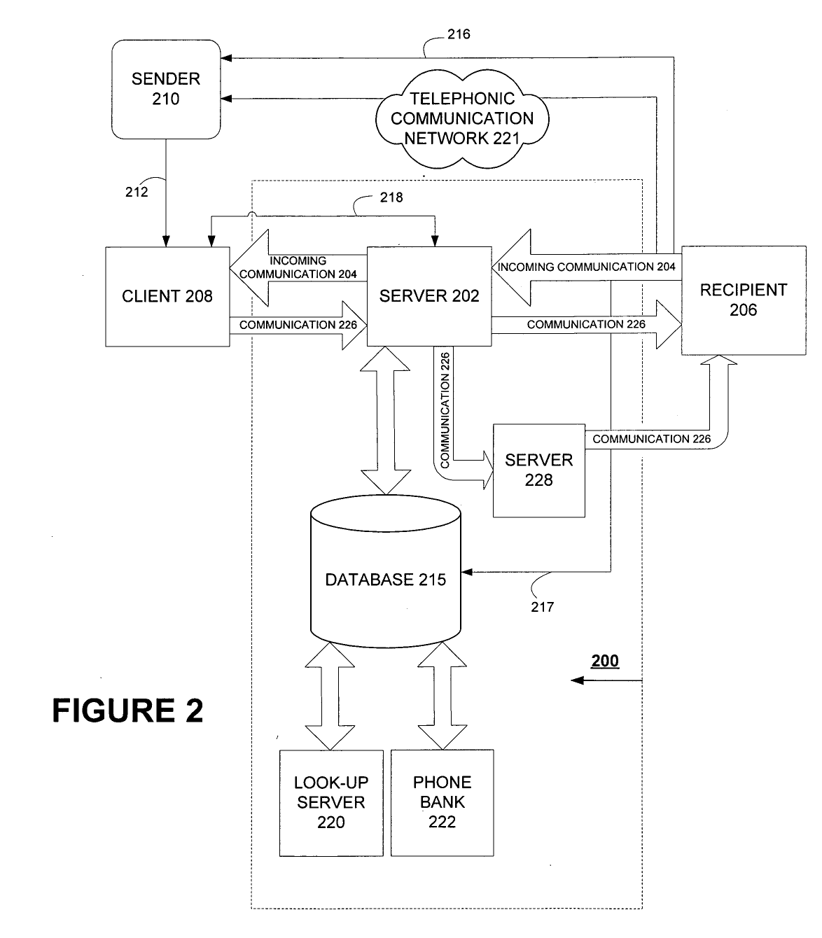

FIG. 1 illustrates an exemplary embodiment of a client-based system 100 according to one embodiment of the invention. The exemplary embodiment of the system 100 is adapted to assist a sender 102 (e.g., an individual or business) to comply with various anti-spam rules, laws, and regulations of different locations (e.g., different states or countries). As shown in FIG. 1, the sender 102 interacts with a client 104 (as indicated by an arrow 106) to send or receive various communications to or from a recipient 108. The client 104 may be email client software such as Microsoft Office Outlook® or Microsoft Outlook Express®, which may send an email to a recipient directly over the Internet or through email server software. The sender 102 may also send various inputs to the client 104 (e.g., an input that indicates if a communication complies with anti-spam rules, laws, and regulations). In this embodiment of the invention, system 100 is illustrated as implemented via client 104 and determines whether communications sent to the recipient 108 comply with various anti-spam rules, laws, and regulations. In general, different locations may adopt anti-spam rules, laws, and regulations with different provisions. For example, different states or different countries may have different anti-spam rules, laws, and regulations. Furthermore, some anti-spam laws may preempt other anti-spam laws. For example, the federal anti-spam laws may preempt parts or all of California's anti-spam laws. As indicated herein and as is known by those skilled in the art, system 100 may also be implemented on a server (as shown in FIG. 2), on a client, or in any other configuration that allows it to determine whether communications sent to recipient 108 comply with anti-spam rules, laws, and regulations.

Many anti-spam rules, laws, and regulations concern the sending of mails to people with whom there is a preexisting business relationship. A preexisting business relationship is typically defined as certain types of incoming communications such as receiving a purchase order, email, or phone call from a customer. According to one embodiment of the invention, recipient 108 may send an incoming communication 110 defining a business relationship to client 104 via a server 112 (e.g., an email server). In this embodiment of the invention, the incoming communication 110 may represent an email, instant messaging message, chat message, or website access. In addition, incoming communication 110 may be transmitted to the server 112 and client 104 via the Internet or World Wide Web (not shown). In an alternative embodiment of the invention, incoming communication 110 may be a postal mail (e.g., return of a warranty card), telephone call, or direct communication between sender 102 and recipient 108 (e.g., face-to-face purchase of merchandise in a store of sender 102). In this alternative embodiment of the invention, incoming communication 110 may be sent directly to sender 102 without via server 112, as indicated by an arrow 114. In yet another alternative embodiment of the invention, client 104 may be bypassed, and incoming communication 110 may be sent directly to a memory area such as a database 118, as indicated by arrows 119. The sender 102 may then submit information regarding incoming communication 110 to client 104, as indicated by the arrow 106.

The software instructions operating client 104 include instructions to receive incoming communication 110, either from server 112 or from sender 102. Depending on the type of incoming communication 110, such instructions may be an email application, an instant messaging application, a chat application, or any other application for receiving or sending communications. In one embodiment of the invention, client 104 also includes software instructions adapted to identify data from incoming communication 110. Specifically, the instructions may identify and generate data indicating a date and time that incoming communication 110 is received by client 104 (or sender 102). The data that indicates the date and time of incoming communication 110 is then stored in the database 118, which may be located at or within client 104 or remotely from client 104. If database 118 does not already have an entry corresponding to recipient 108 (e.g., recipient 108 has not sent a communication to sender 102 previously), then an entry for recipient 108 is created in database 118. Otherwise, client 104 may access database 118 to update the entry for recipient 108 with the data indicating the date and time of incoming communication 110.

Because different locations (e.g. different states or countries) typically have different anti-spam rules, laws, and regulations, it is important to ascertain the location of recipient 108 to comply with the appropriate rules, laws, and regulations. It is typically difficult to ascertain the location of recipient 108 from his or her email address alone. Other forms of incoming communications can be used to help ascertain the location of recipient 108. In particular, client 104 also includes software instructions adapted to identify a location of recipient 108 based on the incoming communication 110 received. The identified location of recipient 108 is then stored in database 118 by creating a new entry for recipient 108 or updating an existing entry for recipient 108 with the identified location. How the software instructions determine the location depends on the type of incoming communication 110. For example, if incoming communication 110 is an email, instant messaging message, chat message, or website access sent via a data communication network (e.g., the Internet), the location of recipient 108 can be identified based on an IP address of recipient 108 or an IP address of a server via which recipient 108 sends incoming communication 110 (e.g., server 112). The client 104 can then map the IP address to a specific location, perhaps via a lookup-server 120 (e.g., a WHOIS server). In addition, the software instructions of client 104 may identify the location of recipient 108 based on a domain name of recipient 108. For example, if recipient 108 has a domain name of “MyName@MyDomain.comjp,” the instructions may identify recipient 108 as located in Japan. In an exemplary embodiment of the invention, software instructions of client 104 may determine the location of recipient 108 by querying the look-up server 120 using the identified IP address or domain name. The look-up server 120 may then send the result of the query to database 118 for storage.

According to one embodiment, incoming communication 110 may be sent to sender 102 via a telephonic communication network 121. In this embodiment of the invention, the instructions of client 104 may identify the location of recipient 108 based on a telephonic address of recipient 108 (e.g., telephone number). The telephonic address of recipient 108 may be obtained from a device capable of identifying the telephonic address from which an incoming telephone call is sent (e.g., a caller identification (ID) machine). Such a device may be embedded in client 104 to provide client 104 the telephonic address. Alternatively, client 104 may directly receive the telephonic address from the device or from sender 102. Software instructions of client 104 may be adapted to send the identified telephonic address to a phone bank 122. The phone bank 122 is adapted to receive the telephonic address and determine a location to which the telephonic address is assigned. Phone bank 122 may then send the determined location of recipient 108 to database 118 for storage. According to another embodiment of the invention, incoming communication 110 may be sent to sender 102 as a postal mail or as a direct communication with sender 102. In such a scenario, the location of recipient 108 may be identified based on a residential or business address of recipient 108 (e.g., as determined from a postal address of the postal mail) and can be directly entered into client 104 by sender 102 or by other methods.

It is possible that client 104 may identify multiple locations of recipient 108 (e.g., recipient 108 may have business addresses in both Portland and Seattle or may have a telephone number in Seattle but an IP address in Portland). According to one exemplary embodiment of the invention, if multiple locations of recipient 108 are identified, the location to be stored in database 118 is the location having the most restrictive anti-spam rules, laws, and regulations among the multiple identified locations. Alternatively, database 118 may store all of the identified locations of recipient 108, and system 100 may at sending time query database 118 to determine whether a particular communication to recipient 108 complies with the most restrictive anti-spam rules, laws, and regulations or with all applicable rules, laws, and regulations. As such, the embodiment of the invention allows sender 102 to comply with the various anti-spam rules, laws, and regulations even if recipient 108 has multiple locations. In accordance with another embodiment of the invention, if client 104 cannot identify a location of recipient 108, client 104 is adapted to store in database 118 a location having the most restrictive anti-spam rules, laws, and regulations as the location of recipient 108. Alternatively, database 108 may store all locations having anti-spam rules, laws, and regulations, and system 100 may at sending time determine whether a communication complies with the most restrictive anti-spam rules, laws, and regulations or with all of the applicable rules, laws, and regulations. This embodiment of the invention allows sender 102 to comply with the various anti-spam rules, laws, and regulations even if sender 102 cannot identify the location of recipient 108.

Client 104 also includes software instructions to send one or more communications 124 to recipient 108. The communication 124 may be part of a mass mailing or may be specifically directed to recipient 108. According to one embodiment, before communication 124 is sent to recipient 108, instructions included in client 104 are adapted to identify a last date and time that incoming communication 110 is received from recipient 108. Preferably, if the last date and time of communication 110 cannot be identified, software instructions of client 104 are adapted to include recipient 104 in a list of recipients whose last date and time of incoming communications cannot be identified. Client 104 is adapted to send or notify sender 102 to send a communication to a recipient included in the list of recipients. This communication is for inducing the recipient to send another incoming communication to the sender in order to establish a relationship and preferably should be sent via a channel permitted by anti-spam rules, laws, and regulations (e.g., via a postal mail). If a recipient on the list of recipients sends another incoming communication and establishes a relationship with sender 102, client 104 may remove the recipient from the list of recipients.

According to an embodiment of the invention, if recipient 108 is not included in the list of recipients whose last date and time of incoming communications cannot be identified, software instructions of client 104 are adapted to determine if recipient 108 is included in a do-not-spam (or do-not-send) list maintained by the federal government, the Direct Marking Association, or any other govern ments or organizations. In one embodiment, database 118 may store a list of recipients or potential recipients who are included in a do-not-spam list, and the instructions of client 104 may determine if recipient 108 is included in a do-not-spam list by accessing the stored list. In another embodiment, the instructions of client 104 may query a do-not-spam list located at another location to determine if recipient 108 is included in such a list. If recipient 108 is included in such a do-not-spam list, client 104 may determine not to send communication 124 to recipient 108 or may send communication 124 to recipient 108 via a compliant channel (e.g., via a postal mail). Alternatively, if there is a preexisting business relationship exception to the do-not-spam list, instructions of client 104 are adapted to determine if a preexisting business relationship exists between sender 102 and recipient 108 by identifying the date and time of the last incoming communication of recipient 108, as described below. If recipient 108 is not included in such a do-not-spam list or if there is a preexisting business relationship exception, software instructions of client 104 are adapted to access database 118 to retrieve data identifying the date and time of the last incoming communication of recipient 108 as well as a location of recipient 108.

After the date and time of the last incoming communication of recipient 108 and the location of recipient 108 are identified, client 104 may determine if the date and time of the last incoming communication of recipient 108 is past the time limit prescribed by anti-spam rules, laws, and regulations of the location of recipient 108. For example, the anti-spam rules, laws, regulations of the location of recipient 108 may prescribe that a business may send a spam to a recipient if it has established a relationship with the recipient within the past three years. As such, if the date and time of the last incoming communication of recipient 108 is more than three years prior to the present time, the time limit prescribed by the anti-spam rules, laws, and regulations is already past. In such a scenario, client 104 may determine not to send communication 124 to recipient 108 or may send communication 124 to recipient 108 via a compliant channel (e.g., via a postal mail). On the other hand, if the date and time of the last incoming communication of recipient 108 is not past the time limit prescribed by the anti-spam rules, laws, and regulations of the location of recipient 108, client 104 may proceed to send communication 124 to recipient 108 via any channel.

In one embodiment of the invention, even if sender 102 and recipient 108 have a preexisting business relationship, client 104 is operated to determine if communication 124 complies with other provisions of the anti-spam rules, laws, and regulations of the location of recipient 108 (e.g., provisions that prohibit commercial solicitations). In this respect, a machine learning or heuristic system located in client 104 or remotely from client 104 may be utilized to determine if communication 124 complies with these other provisions. Sender 102 may also override or confirm the determination of the machine learning or heuristic system by sending an input to client 104. If it is determined that communication 124 complies with provisions of the anti-spam rules, laws, and regulations, client 104 may proceed to send communication 124 to recipient 108 via any channel. If it is determined that communication 124 does not comply with the provisions, client 104 may determine not to send communication 124 to recipient 108 or may send communication 124 to recipient 108 via a compliant channel (e.g., via a postal mail).

In one alternative embodiment of the invention, software instructions included in client 104 may determine whether communication 124 complies with the anti-spam rules, laws, and regulations via textual analysis of the communication 124. If communication 124 is determined not to comply with the anti-spam rules, laws, and regulations, the software instructions may also perform actions that would effect compliance of communication 124 with provisions of the anti-spam rules, laws, and regulations. For example, if required, the instructions may include in communication 124 the address and phone number of sender 102, as well as information regarding to how unsubscribe communication 124. In addition, some regulations require a labeling on an unsolicited communication (e.g., a labeling stating that the communication is an advertisement or that it is unsolicited). As such, if communication 124 is unsolicited, the instructions of client 124 may properly label communication 124 if it is required by the anti-spam rules, laws, and regulations of the location of recipient 108. After effecting compliance of communication 124 with the anti-spam rules, laws, and regulations, client 104 may proceed to send communication 124 to recipient 108.

In an embodiment of the invention, client 104 is adapted to include in communication 124 the time and date of the last incoming communication of recipient 108. Alternatively, this information may be provided to recipient 108 via other means (e.g., by displaying this information on a web page of sender 102 and accessed by recipient 108). In another embodiment of the invention, sender 102 may be a group that has multiple parts or divisions (e.g., sender 102 may have multiple product lines, subsidiaries, or offices). It may be desirable to treat a particular part or division of sender 102 as a separate entity for the purpose of complying with the anti-spam rules, laws, and regulations. In this embodiment, client 104 may keep track of a relationship between recipient 108 and a particular part or division of sender 102. For example, client 104 may identify that incoming communication 110 from recipient 108 is directed to a particular part or division of sender 102. As such, the date and time of incoming communication 110 is stored in database 118 as related to the particular part or division of sender 102. Thereafter, communication 124 may include information or messages specific to a particular part or division of sender 102. For example, communication 124 may include information announcing a new president, a change of address of a particular division, a new product of a particular product line, or may include a coupon for purchasing a product of a particular product line. In such a case, client 104 may include instructions to determine if a particular part or division of sender 102 has a preexisting relationship with recipient 108 (e.g., by determining whether the date and time of the last incoming communication is past the time limit prescribed by the anti-spam rules, laws, and regulations). If recipient 108 has a preexisting relationship with a particular part or division of sender 102, communication 124, which contains information or messages specific to the particular part or division, may then be sent to recipient 108.

In accordance with one embodiment of the invention, client 104 is also adapted to identify if the date and time of the last incoming communication of recipient 108 is approaching the time limit prescribed by the anti-spam rules, laws, and regulations of the location of recipient 108. If the date and time of the last incoming communication of recipient 108 is approaching the time limit, client 104 is adapted to send a communication to recipient 108 in order to induce recipient 108 to send another incoming communication to sender 102. In this embodiment, sender 102 or software instructions of client 104 may specify a range or time window prior to expiration of the prescribed time limit within which a communication for inducing an incoming communication should be sent to recipient 108. For example, sender 102 may specify a six-month range or window such that if the prescribed time limit is three years and if the data stored in database 118 indicates that the last incoming communication of recipient 108 was received two-and-a-half years ago, client 104 is adapted to send a communication to recipient 108 to induce another incoming communication. On the other hand, if the data stored in database 118 indicates that the last incoming communication of recipient 108 was received a year ago, client 104 may determine that a communication to induce another incoming communication from recipient 108 is not needed at this time. This embodiment of the invention advantageously allows sender 102 to renew or maintain an ongoing relationship with recipient 108.

Some anti-spam rules, laws, and regulations or SRO rules allow senders to use some computers, IP addresses, or domains to send compliant communications, while other computers, IP addresses, or domains are not subject to such anti-spam rules, laws, and regulations or SRO rules. Accordingly, in one embodiment of the invention, client 104 may include instructions adapted to route communication 124 to different servers based on whether communication 124 complies with the anti-spam rules, laws, and regulations or SRO rules. As one exemplary embodiment of the invention, if communication 124 complies with the anti-spam rules, laws, and regulations or SRO rules, client 104 is adapted to send communication 124 to recipient 108 via server 112. However, if communication 124 does not comply with the anti-spam rules, laws, and regulations or SRO rules, client 104 is adapted to route communication 124 to a server 126 (e.g., an email server), which then sends the communication 124 to recipient 108. Preferably, the server 126 has a different IP address or domain from that of server 112, thus allowing sender 102 to comply with such anti-spam rules, laws, and regulations or SRO rules.

One or more embodiments of the invention may also be implemented on a server-based system 200 as illustrated in FIG. 2. The system 200 includes a server 202 having capability to receive an incoming communication 204 from a recipient 206 and to send the incoming communication 204 to a client 208 utilized by a sender 210. The client 208 is adapted to interact with the sender 210 and is capable of receiving an input from sender 210, as indicated by an arrow 212. Alternatively, the server 202 may be bypassed, and incoming communication 204 may be sent directly to sender 210 or to a database 215, as indicated by arrows 216 and 217. In this scenario, sender 210 may use client 208 to send information regarding incoming communication 204 (e.g., a telephone number from which incoming communication 204 is transmitted) to server 202, as indicated by an arrow 218.

As part of the software instructions operating the server 202, included are instructions to identifying a date and time of the incoming communication 204 received by client 208 or sender 210 as well as a location of recipient 206. As one exemplary embodiment, if incoming communication 204 is sent via a data communication network, server 202 may query a look-up server 220 to determine the location of recipient 206 using an IP address or domain name of recipient 206 or a server of recipient 206. Alternatively, if incoming communication 204 is sent via a telephonic communication network 221, server 202 may query a phone bank 222 using a telephonic address from which incoming communication 204 is transmitted in order to determine the location of recipient 206. Furthermore, via client 208, sender 210 may send the location of recipient 206 to server 202 if incoming communication 204 is sent to sender 210 directly via a postal mail or a direct communication. Server 202 is further adapted to store data indicating the date and time of incoming communication 204 and the location of recipient 206 in the database 215.

According to one embodiment of the invention, server 202 also has the capability to receive a communication 226 from client 208 and to send the communication 226 to recipient 206. Before communication 226 is sent to recipient 206, software instructions of server 202 are adapted to access database 215 to retrieve data indicating a date and time of the last incoming communication of recipient 206 as well as a location of recipient 206. If the date and time of the last incoming communication of recipient 206 is past a time limit prescribed by the anti-spam rules, laws, and regulations of the location of recipient 206 or if the date and time of the last incoming communication cannot be identified, server 202 may determine not to send communication 226 to recipient 206 or may send communication 226 to recipient 206 via a compliant channel. Additionally, if the date and time of the last incoming communication of recipient 206 cannot be identified, server 202 may send a communication via a compliant channel to recipient 206 to induce recipient 206 to send another incoming communication to sender 210. Such a communication may also be sent to recipient 206 if the date and time of the last incoming communication of recipient 206 is approaching the time limit prescribed by the anti-spam rules, laws, and regulations. Furthermore, server 202 also includes instructions to determine if recipient 206 is included in a do-not-spam list and then decide whether to send communication 226 to recipient 206 (as the preexisting business relationship exception may apply) or whether to send communication 226 to recipient 206 via a compliant channel.

According to other embodiments of the invention, server 202 further includes software instructions (e.g., a machine learning or heuristic system) adapted to determine if communication 226 complies with other provisions of the anti-spam rules, laws, and regulations. Similar to the client-based system 100 as illustrated in FIG. 1, sender 210 using client 208 may override or confirm the determination of the instructions included in server 202 by sending an input to server 202. Server 202 may also include instructions adapted to perform actions that would effect compliance of communication 226 with the anti-spam rules, laws, and regulations (e.g., labeling or provide necessary information in communication 226). Alternatively, if communication 226 does not comply with anti-spam rules, laws, and regulations, server 202 may determine not to send communication 226 to recipient 206 or may send communication 226 to recipient 206 via a compliant channel. In an embodiment of the invention, software instructions of server 202 are adapted to include in communication 226 the date and time of the last incoming communication of recipient 206 in order to allow recipient 206 to confirm or acknowledge the preexisting business relationship between recipient 206 and sender 210. This information regarding the date and time of the last incoming communication of recipient 206 may also be provided to recipient 206 via another channel. In yet another embodiment of the invention, if sender 210 has multiple parts or divisions, server 202 may keep track of relationships between recipient 206 and individual parts or divisions of sender 210, similar to that of the client-based system 100. In further yet another embodiment of the invention, if communication 226 does not comply with certain anti-spam rules, laws, and regulations or SRO rules, server 202 is adapted to route such communication 226 to a server 228 for transmitting communication 226 to recipient 206 while directly sending compliant communications to recipient 206. Preferably, the server 228 has a different IP address or domain from that of server 202.

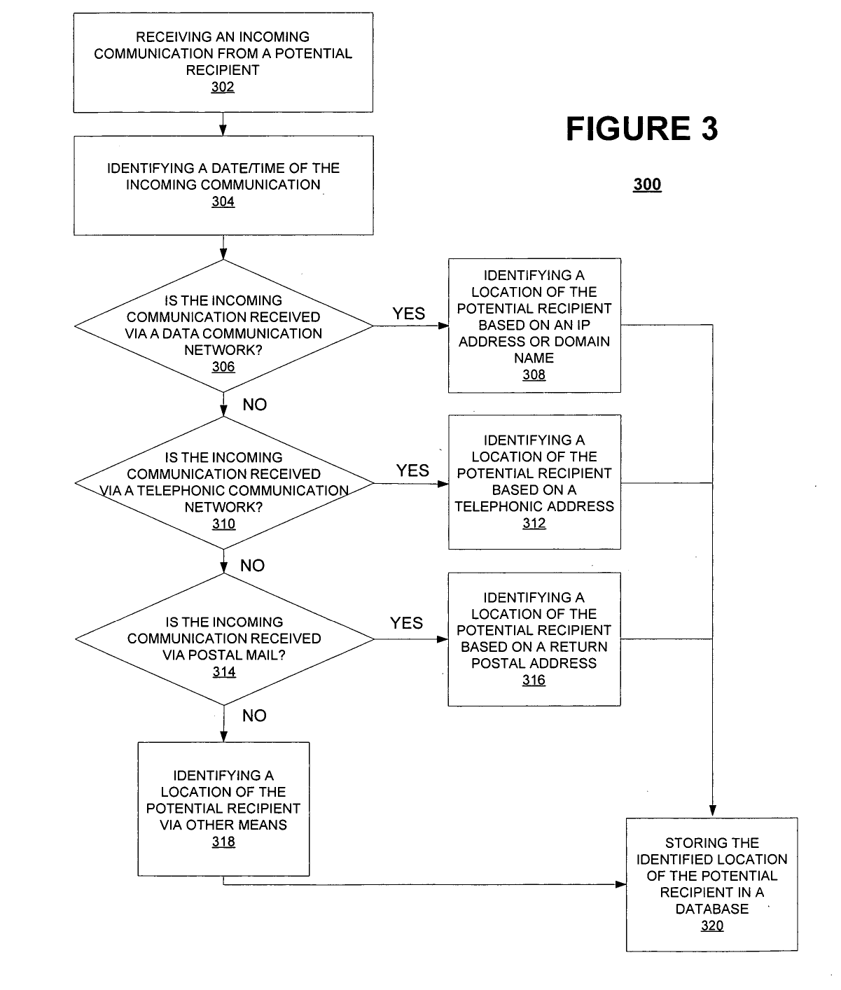

FIG. 3 illustrates generally one method (indicated generally by reference character 300) according to one exemplary embodiment of the invention for identifying a date and time of an incoming communication received from a potential recipient and a location of the potential recipient. At 302, an incoming communication is received from a potential recipient. At 304, a client-based system 100 or a server-based system 200 identifies a date and time that the incoming communication is received. Proceeding to 306, it is determined if the incoming communication is received via a data communication network. If the incoming communication is received via a data communication network, then at 308, a location of the potential recipient is identified based on an IP address or domain name of the potential recipient. If the incoming communication is not received via a data communication network, it is determined at 310 if the incoming communication is received via a telephonic communication network. If so, a location of the potential recipient is identified at 312 based on a telephonic address of the potential recipient. If the incoming communication is not received via a telephonic communication network, it is determined at 314 if the incoming communication is received via a postal mail. If so, a location of the potential recipient is identified at 316 based on a postal address of the potential recipient. If not, the location of the potential recipient may be identified via other means at 318. At 320, if the location of the potential recipient has been identified, the identified location of the potential recipient may then be stored in a database entry associated with the potential recipient.

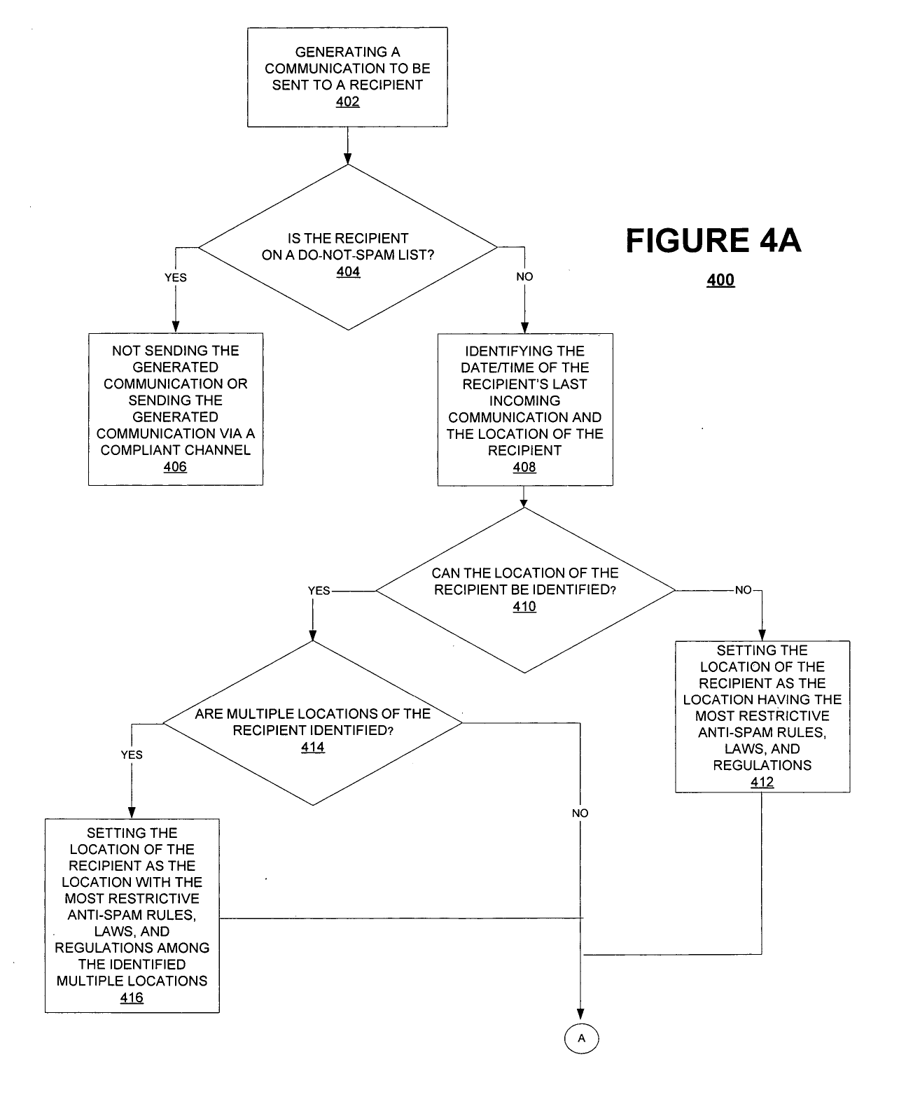

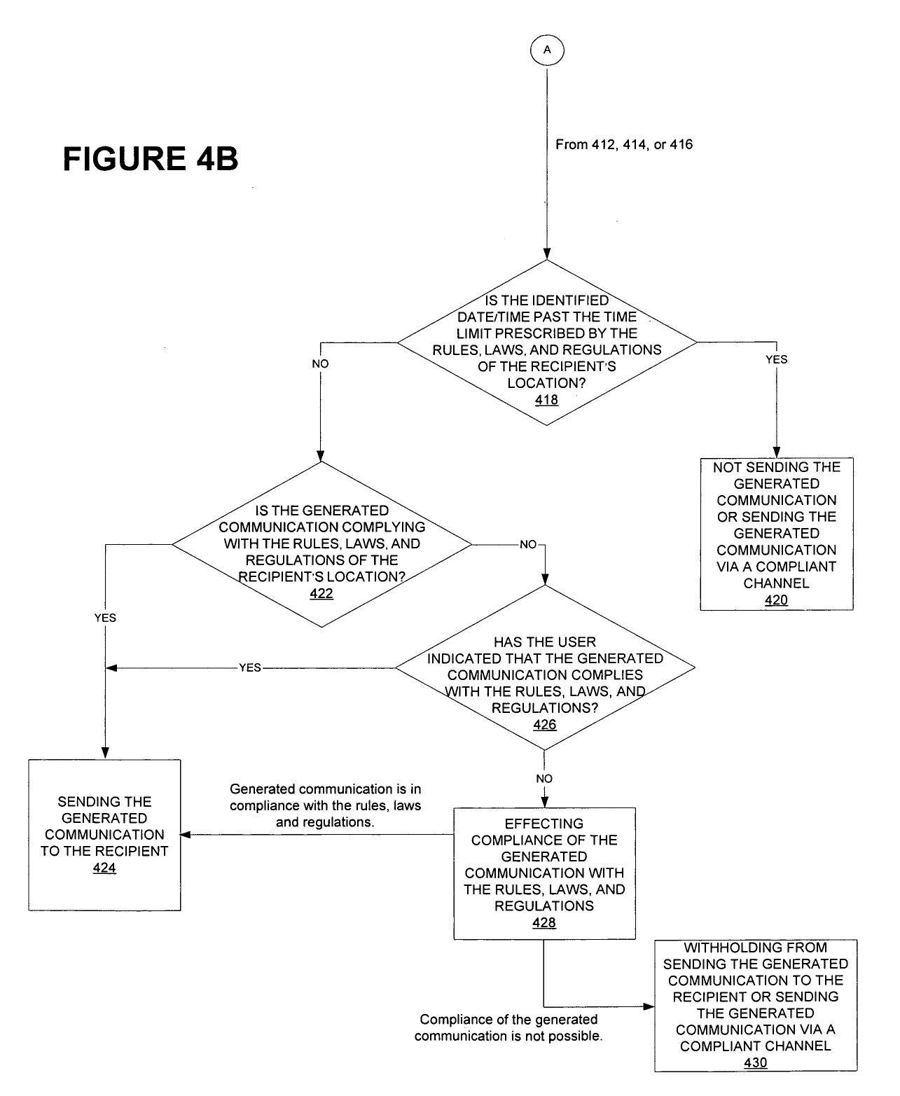

Referring now to FIGS. 4A and 4B, one method (indicated generally by reference character 400) according to one exemplary embodiment of the invention is illustrated for determining if a communication to be sent to a recipient complies with anti-spam rules, laws, and regulations. At 402, a communication to be sent to a recipient is generated. At 404, it is determined if the recipient is included in a do-not-spam list. If so, the generated communication may be sent to the recipient via a compliant channel or may be withheld from sending to the recipient, as indicated at 406. Alternatively, if there is a preexisting business relationship exception to the do-not-spam list, proceed to 408 as if the recipient is not included in the do-not-spam list. At 408, the date and time of the last incoming communication of the recipient and the location of the recipient are identified.

At 410, it is determined if the location of the recipient can be identified. If the location of the recipient cannot be identified, the location of the recipient is set at 412 as the location having the most restrictive anti-spam rules, laws, and regulations. Accordingly, method 400 may later determine if the generated communication complies with the most restrictive anti-spam rules, laws, and regulations, or alternatively, complies with all applicable rules, laws, and regulations. On the other hand, if at 410 the location of the recipient can be identified, it is determined at 414 if multiple locations of the recipient are identified. If this is true, the location of the recipient is set at 416 as the location with the most restrictive anti-spam rules, laws, and regulations among the identified multiple locations. Alternatively, the rules, laws, and regulations of all of the identified multiple locations may be used to later determine if the generated communication complies with such different rules, laws, and regulations. After the location of the recipient is identified or set, proceed to 418 of FIG. 4B.

At 418, it is determined if the identified date and time of the last incoming communication of the recipient is past a time limit prescribed by the anti-spam rules, laws, and regulations of the location of the recipient. If so, at 420, the generated communication may be withheld from sending to the recipient or may be sent to the recipient via a compliant channel (e.g., via a postal mail). If the identified date and time of the last incoming communication of the recipient is not past the prescribed time limit, it is determined at 422 if the generated communication complies with other provisions of the anti-spam rules, laws, and regulations adopted or proposed by the location of the recipient (e.g., via textual analysis of the generated communication). If so, the generated communication is sent to the recipient via any channel at 424. If not, it is determined at 426 if the sender has indicated that the generated communication complies with the anti-spam rules, laws, and regulations. If so, the generated communication is sent to the recipient at 424. If not, compliance of the generated communication with the anti-spam rules, laws, and regulations is effected at 428. For example, if required, the generated communication may be labeled as unsolicited or may be appended the address and phone number of the sender as well as unsubscription information. After the generated communication is labeled in compliance with the regulations, the generated communication is sent to the recipient at 424. If compliance with the anti-spam rules, laws, and regulations is not possible, then the generated communication may be withheld at 430 from being sent to the recipient or may be sent to the recipient via a compliant channel.

Although not illustrated, information regarding the date and time of the last incoming communication of the recipient may also be sent to the recipient. This information may be sent along with the generated communication or may be sent separately. Furthermore, relationships between the recipient and individual parts or divisions of the sender may be tracked, and the generated communication may be sent to the recipient based on such relationships. In addition, the generated communication may be routed to a first computer if the generated communication complies with the anti-spam rules, laws, and regulations or to a second computer if the generated communication does not comply with the anti-spam rules, laws, and regulations. Preferably, the second computer has a different IP address or domain from that of the first computer.

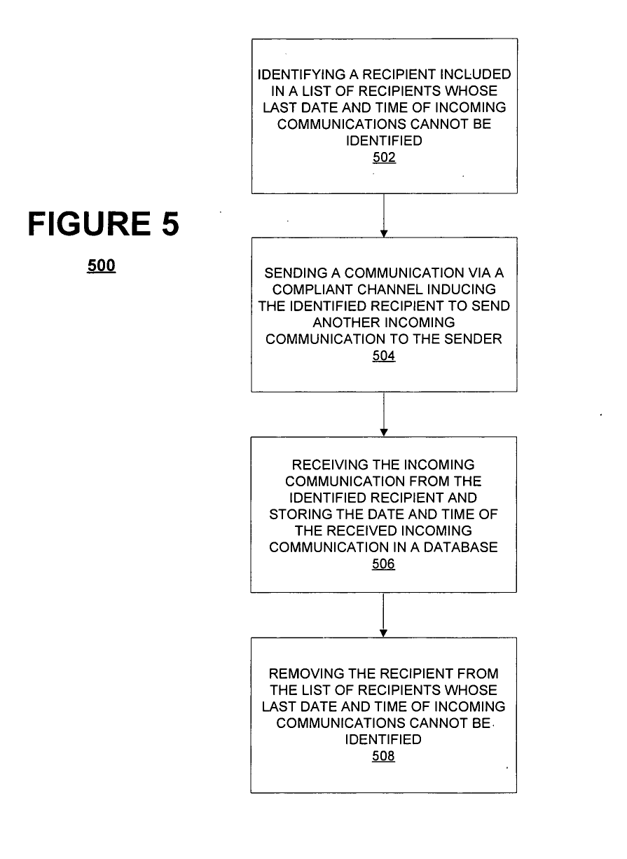

FIG. 5 illustrates generally one method (indicated generally by reference character 500) according to one exemplary embodiment of the invention for a sender to establish or reestablish a preexisting business relationship with a recipient. In one embodiment of the invention, a database may maintain a list of recipients whose last date and time of incoming communications cannot be identified. Accordingly, at 502, the database may be queried to identify a recipient included in the list of recipients whose last date and time of incoming communications cannot be identified. At 504, a communication is sent to the identified recipient via a channel permitted by the anti-spam rules, laws, and regulations of the recipient's location (e.g., via a postal mail) to induce the recipient to send another incoming communication to the sender. After the sender receives an incoming communication from the recipient, a business relationship between the sender and the recipient is reestablished. Accordingly, the date and time of the received incoming communication is stored in the database at 506, and the recipient is removed from such a list at 508.

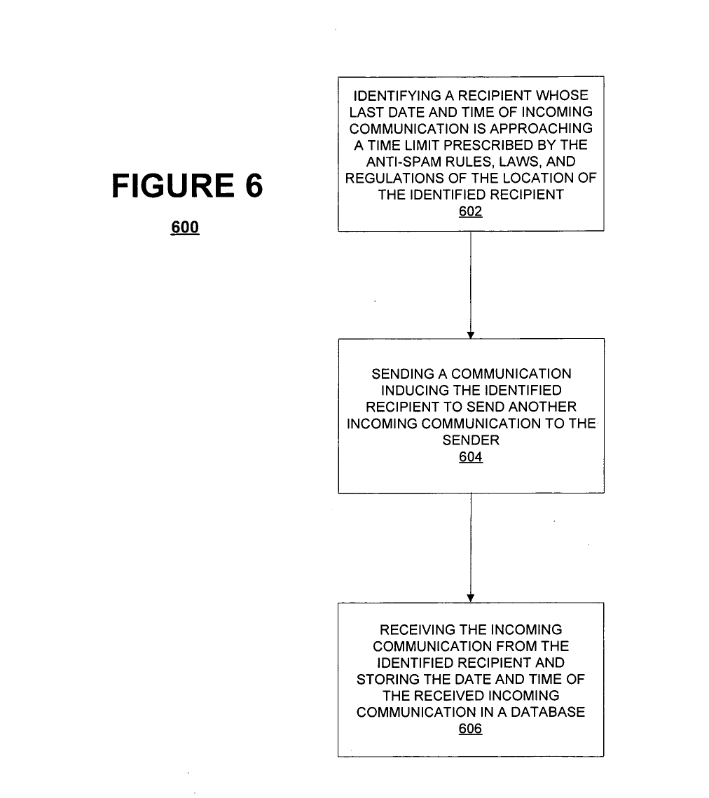

FIG. 6 illustrates generally one method (indicated generally by reference character 600) according to one exemplary embodiment of the invention for a sender to maintain a preexisting business relationship with a recipient. At 602, a system such as system 100 or 200 may query a database to identify a recipient whose last date and time of incoming communication is approaching a time limit prescribed by the anti-spam rules, laws, and regulations of the location of the identified recipient. In order to maintain the preexisting business relationship with the identified recipient, a communication is sent to the identified recipient at 604 to induce the recipient to send another incoming communication to the sender. After the sender receives an incoming communication from the recipient, the date and time of the received incoming communication is then stored in the database at 606. As such, method 600 allows the sender to extend the preexisting business relationship with the recipient.

It is to be understood that the methods illustrated in FIGS. 3-6 may be implemented manually or via software. Furthermore, the illustrated orders of the methods are for illustration purpose. Accordingly, they do not require any defined order of steps. It is contemplated that any particular step of the methods may be performed before, contemporaneously with, or after another step without changing the scope of embodiments of the invention.

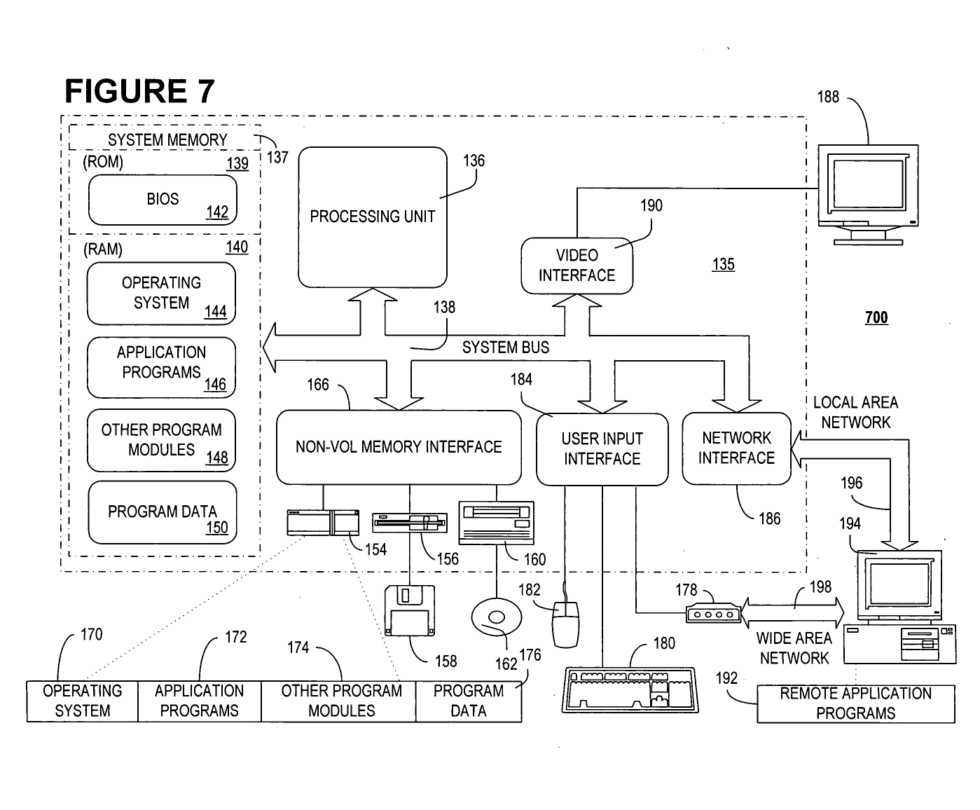

FIG. 7 shows one example of a general purpose computing device in the form of a computer 135. In one embodiment of the invention, a computer such as the computer 135 is suitable for use in client 104, client 208, server 112, server 126, server 202, server 228, or any other figures illustrated and described herein. Computer 135 has one or more processors or processing units 136 and a system memory 137. In the illustrated embodiment, a system bus 138 couples various system components including the system memory 137 to the processors 136. The bus 138 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 135 typically has at least some form of computer readable media. Computer readable media, which include both volatile and nonvolatile media, removable and non-removable media, may be any available medium that can be accessed by computer 135. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computer 135. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristic set or changed in such a manner as to encode information in the signal. Wired media, such as a wired network or direct-wired connection, and wireless media, such as acoustic, RF, infrared, and other wireless media, are examples of communication media. Combinations of the any of the above are also included within the scope of computer readable media.

The system memory 137 includes computer storage media in the form of removable and/or non-removable, volatile and/or nonvolatile memory. In the illustrated embodiment, system memory 137 includes read only memory (ROM) 139 and random access memory (RAM) 140. A basic input/output system 142 (BIOS), containing the basic routines that help to transfer information between elements within computer 135, such as during start-up, is typically stored in ROM 139. RAM 140 typically contains data and/or program modules that are immediately accessible to and/or presently being operated on by processing unit 136. By way of example, and not limitation, FIG. 7 illustrates operating system 144, application programs 146, other program modules 148, and program data 150.

The computer 135 may also include other removable/non-removable, volatile/nonvolatile computer storage media. For example, FIG. 7 illustrates a hard disk drive 154 that reads from or writes to non-removable, nonvolatile magnetic media. FIG. 7 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 138 by a non-volatile memory interface, such as interface 166.

The drives or other mass storage devices and their associated computer storage media discussed above and illustrated in FIG. 7, provide storage of computer readable instructions, data structures, program modules and other data for the computer 135. In FIG. 7, for example, hard disk drive 154 is illustrated as storing operating system 170, application programs 172, other program modules 174, and program data 176. Note that these components can either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 135 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 136 through a user input interface 184 that is coupled to system bus 138, but may be connected by other interface and bus structures, such as a parallel port, game port, or a Universal Serial Bus (USB). A monitor 188 or other type of display device is also connected to system bus 138 via an interface, such as a video interface 190. In addition to the monitor 188, computers often include other peripheral output devices (not shown) such as a printer and speakers, which may be connected through an output peripheral interface (not shown).

The computer 135 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 135. The logical connections depicted in FIG. 7 include a local area network (LAN) 196 and a wide area network (WAN) 198, but may also include other networks. LAN 138 and/or WAN 139 can be a wired network, a wireless network, a combination thereof, and so on. Such networking environments are commonplace in offices, enterprise-wide computer networks, intranets, and global computer networks (e.g., the Internet).

When used in a local area networking environment, computer 135 is connected to the LAN 196 through a network interface or adapter 186. When used in a wide area networking environment, computer 135 typically includes a modem 178 or other means for establishing communications over the WAN 198, such as the Internet. The modem 178, which may be internal or external, is connected to system bus 138 via the user input interface 184, or other appropriate mechanism. In a networked environment, program modules depicted relative to computer 135, or portions thereof, may be stored in a remote memory storage device (not shown). By way of example, and not limitation, FIG. 7 illustrates remote application programs 192 as residing on the memory device. It will be appreciated that the network connections shown are exemplary and other means of establishing a communications link between the computers may be used.

Generally, the data processors of computer 135 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. Embodiments of the invention described herein include these and other various types of computer-readable storage media when such media contain instructions or programs for implementing the steps described below in conjunction with a microprocessor or other data processor. Embodiments of the invention also include the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 135, an embodiment of the invention is operational with numerous other general purpose or special purpose computing system environments or configurations. The computing system environment is not intended to suggest any limitation as to the scope of use or functionality of embodiments of the invention. Moreover, the computing system environment should not be interpreted as having any dependency or requirement relating to any one or combination of components illustrated in the exemplary operating environment. Examples of well known computing systems, environments, and/or configurations that may be suitable for use with embodiments of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

One embodiment of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. One embodiment of the invention may also be practiced in distributed computing environments where tasks are performed by remote processing devices that are linked through a data communication network. In a distributed computing environment, program modules may be located in both local and remote computer storage media including memory storage devices.

In operation, computer 135 executes computer-executable instructions such as those illustrated in FIGS. 1-4B for a sender of communications to comply with a predetermined time limit. Computer-executable instructions are adapted to receive an incoming communication from a recipient of communications. Computer-executable instructions are adapted to store data indicating a last time that the incoming communication is received by the sender. Computer-executable instructions are adapted to send a communication to the recipient if the stored data indicates that the time between the last time that the incoming communication is received by the sender and a present time does not exceed the predetermined time limit.

The order of execution or performance of the methods illustrated and described herein is not essential, unless otherwise specified. That is, it is contemplated by the inventors that elements of the methods may be performed in any order, unless otherwise specified, and that the methods may include more or less elements than those disclosed herein.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of embodiments of the invention, it is intended that all matter contained in the above description and shown in the accompanying drawings shall be interpreted as illustrative and not in a limiting sense.

1. A method for a sender of communications to comply with a predetermined time limit, comprising:
receiving an incoming communication from a recipient of communications;
storing data indicating a last time that the incoming communication is received by the sender; and
sending a communication to the recipient if the stored data indicates that the time between the last time that the incoming communication is received by the sender and a present time does not exceed the predetermined time limit.

2. The method of claim 1, wherein the incoming communication is received via one or more of the following: a direct communication, a postal mail, a data communication network, or a telephonic communication network.

3. The method of claim 1, further comprising sending information to the recipient, said information indicating the last time that the incoming communication from the recipient is received.

4. The method of claim 1, wherein said sending comprises sending the communication to the recipient if the stored data indicates that the present time is within a range prior to expiration of the predetermined time limit, said communication for inducing said recipient to send another incoming communication to the sender.

5. The method of claim 1, wherein if the time between the last time that the incoming communication is received and the present time exceeds the predetermined time limit, the communication is sent to the recipient via a channel permitted by a rule, law, or regulation that prescribes the predetermined time limit.

6. The method of claim 1, further comprising:
storing a list of recipients whose last time of incoming communications to the sender cannot be identified; and
wherein said sending the communication comprises sending the communication to the recipient if the recipient is included in said list of recipients, said communication for inducing the recipient to send another incoming communication to the sender.

7. The method of claim 6, further comprising removing the recipient from said list of recipients after the recipient has sent another incoming communication to the sender.

8. The method of claim 1, further comprising:
storing a list of recipients who are included in a do-not-send list;
identifying if the recipient is included in said list of recipients; and
wherein said sending the communication comprises sending the communication to the recipient via a permitted channel if the recipient is included in said list of recipients.

9. The method of claim 8, wherein said sending further comprises sending the communication to the recipient via any channel if the recipient is included in said list of recipients and the time between the last time that the incoming communication is received and the present time does not exceed the predetermined time limit.

10. The method of claim 1, wherein the sender is a group, wherein said incoming communication from the recipient is received by one of the group, wherein said storing comprises storing data indicating the last time that the incoming communication is received by said one of the group, and wherein said sending comprises sending the communication from said one of the group to the recipient if the time between the last time that the incoming communication is received by said one of the group and the present time does not exceed the predetermined time limit.

11. The method of claim 1, wherein one or more computer-readable media have computer-executable instructions for performing the method recited in claim 1.

12. A method for a sender of communications to comply with a rule, law, or regulation, comprising:
receiving an incoming communication from a recipient of communications;
identifying a location of the recipient based on the received incoming communication;
storing data indicating the identified location of the recipient;
determining if a communication complies with a rule, law, or regulation of the identified location of the recipient; and
sending the communication to the recipient if the communication is determined to comply with the rule, law, or regulation of the identified location of the recipient.

13. The method of claim 12, wherein said determining if the communication complies with the rule, law, or regulation of the identified location of the recipient comprises determining if the communication complies with the rule, law, or regulation via textual analysis of the communication.

14. The method of claim 12, wherein said determining if the communication complies with the rule, law, or regulation is performed in an electronic mail client.

15. The method of claim 12, wherein said sending the communication comprises sending the communication to the recipient via a channel permitted by the rule, law, or regulation of the identified location of the recipient if the communication is determined not to comply with the rule, law, or regulation.

16. The method of claim 15, further comprising:
receiving an input from the sender, said input indicating whether the communication complies with the rule, law, or regulation; and
wherein said sending the communication comprises sending the communication to the recipient via any channel if the received input indicates that the communication complies with the rule, law, or regulation.

17. The method of claim 12, wherein the location of the recipient is identified based on a postal address if the postal address is provided with the incoming communication, wherein the location of the recipient is identified based on an internet protocol address, server location, or domain name of the recipient if the incoming communication is received via a data communication network, and wherein the location of the recipient is identified based on a telephonic address of the recipient if the incoming communication is received via a telephonic communication network.

18. The method of claim 12, wherein if multiple locations of the recipient are identified, the location of the recipient is the location having the most restrictive rule law, or regulation among the identified multiple locations.

19. The method of claim 12, wherein the location of the recipient is a location having the most restrictive rule, law, or regulation if the location of the recipient cannot be identified.

20. The method of claim 12, wherein said sending the communication to the recipient comprises:
effecting compliance of the communication with the rule, law, or regulation of the identified location of the recipient if the communication is determined not to comply with the rule, law, or regulation; and
sending the compliant communication to the recipient.

21. The method of claim 20, wherein said effecting compliance of the communication comprises including one or more of the following information in the communication if required by the rule, law, or regulation of the identified location of the recipient: a labeling that the communication is unsolicited, an address of the sender, a phone number of the sender, or unsubscription information.

22. The method of claim 12, further comprising using a first computer having a first internet protocol address or domain to send the communication to the recipient if the communication is determined to comply with the rule, law, or regulation of the identified location of the recipient and using a second computer having a second internet protocol address or domain different from the first internet protocol address or domain to send the communication to the recipient if the communication is determined not to comply with the rule, law, or regulation of the identified location of the recipient.

23. The method of claim 12, wherein one or more computer-readable media have computer-executable instructions for performing the method recited in claim 12.

24. A system for a sender of communications to comply with a predetermined time limit, comprising:
a memory area adapted to store data indicating a last time that an incoming communication from a recipient is received by the sender; and
a device adapted to send a communication to the recipient if the stored data indicates that the time between the last time that the incoming communication is received by the sender and a present time does not exceed the predetermined time limit.

25. The system of claim 24, wherein said device is a telephonic device, a server, or a client.

26. The system of claim 24, wherein the device is adapted to send the communication to the recipient if the stored data indicates that the present time is within a range prior to expiration of the predetermined time limit, said communication for inducing said recipient to send another incoming communication to the sender.

27. The system of claim 24, wherein the memory area is adapted to store a list of recipients whose last time of incoming communications to the sender cannot be identified, wherein the device is adapted to send the communication to the recipient if the recipient is included in said list of recipients, said communication for inducing the recipient to send another incoming communication to the sender, and further comprising computer-executable instructions to remove the recipient from said list of recipients after the recipient has sent another incoming communication to the sender.

28. The system of claim 24, wherein the sender is a group, wherein the memory area is adapted to store data indicating the last time that the incoming communication from the recipient is received by one of the group, and wherein the device is adapted to send the communication from said one of the group to the recipient if the time between the last time that the incoming communication is received by said one of the group and the present time does not exceed the predetermined time limit.

29. A system for a sender of communications to comply with a rule, law, or regulation, comprising:
computer-executable instructions to identify a location of a recipient based on an incoming communication received from the recipient;
a memory area adapted to store data indicating the identified location of the recipient;
computer-executable instructions to determine if a communication complies with a rule, law, or regulation of the identified location of the recipient; and
a first device adapted to send the communication to the recipient if the communication is determined to comply with the rule, law, or regulation of the identified location of the recipient.

30. The system of claim 29, wherein said computer-executable instructions to determine if the communication complies with the rule, law, or regulation comprises electronic mail client instructions.

31. The system of claim 29, wherein the location of the recipient is identified based on a postal address if the postal address is provided with the incoming communication, wherein the location of the recipient is identified based on an internet protocol address, server location, or domain name of the recipient if the incoming communication is received via a data communication network, and wherein the location of the recipient is identified based on a telephonic address of the recipient if the incoming communication is received via a telephonic communication network.

32. The system of claim 29, wherein the first device is adapted to send the communication to the recipient via a channel permitted by the rule, law, or regulation of the identified location of the recipient if the communication is determined not to comply with the rule, law, or regulation.

33. The system of claim 32, further comprising:
computer-executable instructions to receive an input from the sender, said input indicating whether the communication complies with the rule, law, or regulation; and
wherein the first device is adapted to send the communication to the recipient via any channel if the received input indicates that the communication complies with the rule, law, or regulation.

34. The system of claim 29, further comprising computer-executable instructions to effect compliance of the communication with the rule, law, or regulation of the identified location of the recipient if the communication is determined not to comply with the rule, law, or regulation, and wherein the first device is adapted to send the compliant communication to the recipient.

35. The system of claim 29, further comprising:
a second device having a second internet protocol address or domain and adapted to send the communication to the recipient if the communication is determined not to comply with the rule, law, or regulation of the identified location of the recipient; and
wherein the first device has a first internet protocol address or domain different from the second internet protocol address or domain and is adapted to send the communication to the recipient if the communication is determined to comply with the rule, law, or regulation of the identified location of the recipient.

36. One or more computer-readable media having computer-executable components for a sender of communications to comply with a predetermined time limit, said computer-readable media comprising:
a receiving component for receiving an incoming communication from a recipient of communications;
a storage component for storing data indicating a last time that the incoming communication is received by the sender; and
a sending component for sending a communication to the recipient if the stored data indicates that the time between the last time that the incoming communication is received by the sender and a present time does not exceed the predetermined time limit.

37. The computer-readable media of claim 36, wherein the sending component sends the communication to the recipient if the stored data indicates that the present time is within a range prior to expiration of the predetermined time limit, said communication for inducing said recipient to send another incoming communication to the sender.

38. The computer-readable media of claim 36, wherein the storage component stores a list of recipients whose last time of incoming communications to the sender cannot be identified, and wherein the sending component sends the communication to the recipient if the recipient is included in said list of recipients, said communication for inducing the recipient to send another incoming communication to the sender.

39. The computer-readable media of claim 36, wherein the storage component stores a list of recipients who are included in a do-not-send list, and wherein the sending component sends the communication to the recipient via a permitted channel if the recipient is included in said list of recipients.

40. The computer-readable media of claim 36, wherein the sender is a group, wherein said incoming communication from the recipient is received by one of the group, wherein the storage component stores data indicating the last time that the incoming communication is received by said one of the group, and wherein the sending component sends the communication from said one of the group to the recipient if the time between the last time that the incoming communication is received by said one of the group and the present time does not exceed the predetermined time limit.
